(19) United States
(12) Patent Application Publication
(10) Pub. No.: US 2024/0244165 A1
(43) Pub. Date: Jul. 18, 2024

(54) DIGITAL PROJECTOR FOR GENERATING PROJECTED IMAGES THROUGH TIMING CONTROL

(71) Applicant: ASTI GLOBAL INC., TAIWAN, Taichung City (TW)

(72) Inventors: CHIEN-SHOU LIAO, Taichung City (TW); YING-CHIEH CHEN, Taichung City (TW)

(21) Appl. No.: 18/399,612

(22) Filed: Dec. 28, 2023

Related U.S. Application Data
(60) Provisional application No. 63/439,398, filed on Jan. 17, 2023.
(60) Provisional application No. 63/439,407, filed on Jan. 17, 2023.
(60) Provisional application No. 63/439,422, filed on Jan. 17, 2023.

(51) Int. Cl. H04N 9/31

(52) U.S. Cl. CPC H04N 9/3155; H04N 9/3105; H04N 9/317

(57) ABSTRACT

A digital projector for generating projected images through timing control, which includes a light providing module, an image generating module, an optical component module and a projection lens module. The light providing module includes a plurality of light-emitting chip units that are configured to be turned on asynchronously within a predetermined time through timing control, thereby enabling the light providing module to generate a projection beam. The image generating module is configured to allow the projection beam to pass through, thereby converting the projection beam into an image beam. The projection lens module is configured to project the image beam to a predetermined position. The digital projector can generate projected images in a sequential control manner through the cooperation of the light providing module, the image generating module, the optical component module and the projection lens module.

### CROSS-REFERENCE TO RELATED PATENT APPLICATION

This application claims the benefit of priorities to the U.S. Provisional Patent Application Ser. No. 63/439,398, filed on Jan. 17, 2023, Ser. No. 63/439,407, filed on Jan. 17, 2023, and Ser. No. 63/439,422 filed on Jan. 17, 2023, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a digital projector, and more particularly to a digital projector for generating projected images through timing control.

### BACKGROUND OF THE DISCLOSURE

In the related art, projectors have been widely used to project image information on a screen, but the projectors still have room for improvement.

### SUMMARY OF THE DISCLOSURE

In response to the above-referenced technical inadequacy, the present disclosure provides a digital projector for generating projected images through timing control, by using one or more transmissive liquid crystal display (LCD) panels, one or more reflective LCD panels, or one or more digital micromirror device (DMD) chips.

In order to solve the above-mentioned problems, one of the technical aspects adopted by the present disclosure is to provide a digital projector for generating projected images through timing control, which includes a light providing module, an image generating module, an optical component module and a projection lens module. The light providing module includes a plurality of light-emitting chip units. The image generating module is configured to be disposed at a predetermined position adjacent to the light providing module. The optical component module is configured to be disposed at a predetermined position adjacent to the image generating module. The projection lens module is configured to be disposed at a predetermined position adjacent to the optical component module. The light providing module, the image generating module, the optical component module and the projection lens module are configured to be disposed on a same optical path. The light-emitting chip units of the light providing module are configured to be turned on asynchronously within a predetermined time through timing control, thereby enabling the light providing module to generate a projection beam. The image generating module is configured to allow the projection beam to pass through, thereby converting the projection beam into an image beam. The projection lens module is configured to project the image beam to a predetermined position.

In order to solve the above-mentioned problems, another one of the technical aspects adopted by the present disclosure is to provide a digital projector for generating projected images through timing control, which includes a light providing module, an image generating module, an optical component module and a projection lens module. The light providing module includes a plurality of light-emitting chip units. The image generating module is configured to be disposed at a predetermined position adjacent to the light providing module. The optical component module is configured to be disposed at a predetermined position adjacent to the image generating module. The projection lens module is configured to be disposed at a predetermined position adjacent to the optical component module. The light providing module, the image generating module, the optical component module and the projection lens module are configured to be disposed on a same optical path. The light-emitting chip units of the light providing module are configured to be turned on asynchronously within a predetermined time through timing control, thereby enabling the light providing module to generate a projection beam. The image generating module is configured to reflect the projection beam, thereby converting the projection beam into an image beam. The projection lens module is configured to project the image beam to a predetermined position.

Therefore, in the digital projector for generating the projected images through timing control provided by the present disclosure, by virtue of “the light-emitting chip units of the light providing module being configured to be turned on asynchronously within a predetermined time through timing control, thereby enabling the light providing module to generate a projection beam,” “the image generating module being configured to allow the projection beam to pass through, thereby converting the projection beam into an image beam,” and “the projection lens module being configured to project the image beam to a predetermined position,” the digital projector provided by the present disclosure can generate projected images in a sequential control manner (or a time-sequence controlled manner) through the cooperation of the light providing module, the image generating module, the optical component module and the projection lens module.

Furthermore, in the digital projector for generating the projected images through timing control provided by the present disclosure, by virtue of “the light-emitting chip units of the light providing module being configured to be turned on asynchronously within a predetermined time through timing control, thereby enabling the light providing module to generate a projection beam,” “the image generating module being configured to reflect the projection beam, thereby converting the projection beam into an image beam,” and “the projection lens module being configured to project the image beam to a predetermined position,” the digital projector provided by the present disclosure can generate projected images in a sequential control manner (or a time-sequence controlled manner) through the cooperation of the light providing module, the image generating module, the optical component module and the projection lens module.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of a digital projector for generating projected images through timing control according to a first embodiment of the present disclosure;

FIG. 2 is a schematic diagram showing that each light-emitting chip unit provided by the present disclosure can be a multi-chip structure (using red light-emitting chips, green light-emitting chips and blue light-emitting chips);

FIG. 3 is a schematic diagram showing that each light-emitting chip unit provided by the present disclosure can be a single-chip structure (using a blue light-emitting chip and a phosphor layer);

FIG. 4 is a schematic view of the digital projector for generating projected images through timing control according to a second embodiment of the present disclosure;

FIG. 5 is a schematic view of the digital projector for generating projected images through timing control according to a third embodiment of the present disclosure;

FIG. 6 is a schematic view of the digital projector for generating projected images through timing control according to a fourth embodiment of the present disclosure;

FIG. 7 is a schematic view of the digital projector for generating projected images through timing control according to a fifth embodiment of the present disclosure; and

FIG. 8 is a schematic view of the digital projector for generating projected images through timing control according to a sixth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

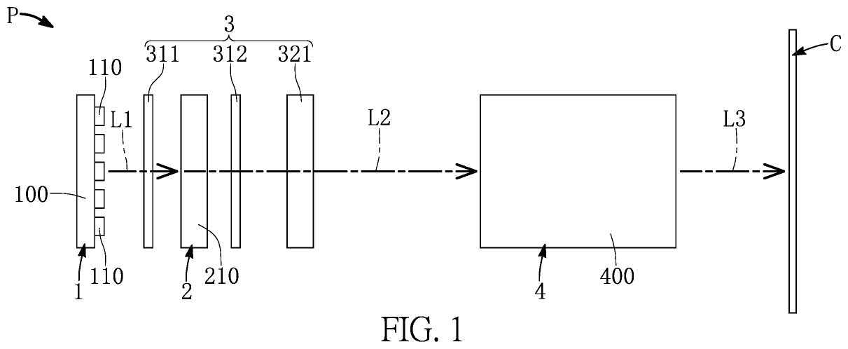

Referring to FIG. 1 to FIG. 3, a first embodiment of the present disclosure provides a digital projector P for generating projected images through timing control, which includes a light providing module 1 (or a light generating module), an image generating module 2 (or an image providing module), an optical component module 3 and a projection lens module 4, and the light providing module 1, the image generating module 2, the optical component module 3 and the projection lens module 4 can be configured to be disposed on a same optical path. It is worth noting that, in order to facilitate the description of the present disclosure, the outer casing of the digital projector P is omitted in the drawings.

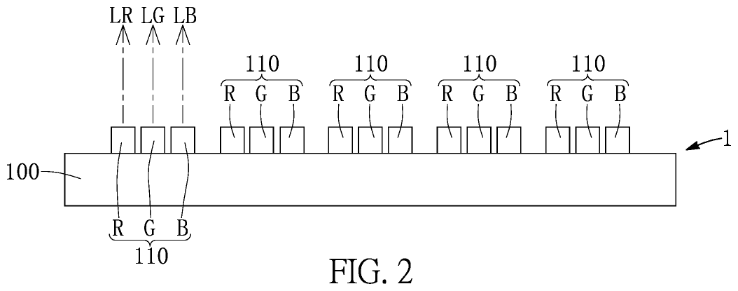

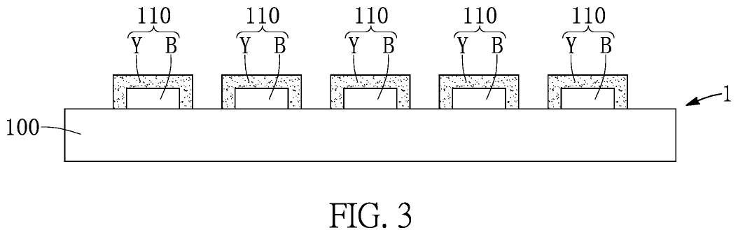

Firstly, referring to FIG. 1, FIG. 2 and FIG. 3, the light providing module 1 includes a plurality of light-emitting chip units 110, and the light-emitting chip units 110 of the light providing module 1 can be configured to be turned on asynchronously (in an asynchronous manner) within a predetermined time through timing control (or sequential control), thereby enabling the light providing module 1 to generate a projection beam L1 (or a projection light source). For example, the light-emitting chip units 110 of the light providing module 1 can be configured to be turned on sequentially to present a plurality of point light sources (i.e., each point light source is generated by a single light-emitting chip unit 110) or a plurality of line light sources (i.e., each line light source is generated by a plurality of light-emitting chip units 110 arranged in a row), so that neither the point light source nor the line light source will be turned on at the same time. Moreover, the light providing module 1 further includes a circuit substrate 100 having a timing control circuit (i.e., a circuit layout for providing timing control), the light-emitting chip units 110 can be disposed on the circuit substrate 100 in a predetermined arrangement shape (such as an array shape or a matrix shape) and electrically connected to the circuit substrate 100, and the light-emitting chip units 110 are configured to be not turned on simultaneously, thereby reducing heat transmitted from the light-emitting chip units 110 to the circuit substrate 100. It is worth noting that the circuit substrate 100 can also be equipped with a heat sink to improve the heat dissipation effect. However, the aforementioned details are disclosed for exemplary purposes only, and are not meant to limit the scope of the present disclosure.

For example, each of the light-emitting chip units 110 can be a multi-chip structure or a single-chip structure. More particularly, as shown in FIG. 2, when each of the light-emitting chip units 110 is a multi-chip structure, each of the light-emitting chip units 110 includes a red light-emitting chip R configured to generate a red light beam LR, a green light-emitting chip G configured to generate a green light beam LG, and a blue light-emitting chip B configured to generate a blue light beam LB, the red light beam LR generated by the red light-emitting chip R, the green light beam LG generated by the green light-emitting chip G, and the blue light-emitting chip B generated by the blue light-emitting chip B can cooperate with each other to form a white light beam that is provided by each of the light-emitting chip units 110, and the red light-emitting chips R, the green light-emitting chips G and the blue light-emitting chips B provided by each of the light-emitting chip units 110 may all be light-emitting diode chips (i.e., LED chips) or laser diode chips (i.e., LD chips). In addition, as shown in FIG. 3, when each of the light-emitting chip units 110 is a single-chip structure, each of the light-emitting chip units 110 includes a blue light-emitting chip B and a phosphor layer Y for covering the blue light-emitting chip B, the blue light beam (not shown in figures) generated by the blue light-emitting chip B can pass through the phosphor layer Y to form a white light beam that is provided by each of the light-emitting chip units 110, and the blue light-emitting chip B provided by each of the light-emitting chip units 110 can be an LED chip or an LD chip. However, the aforementioned details are disclosed for exemplary purposes only, and are not meant to limit the scope of the present disclosure.

Furthermore, as shown in FIG. 1, the image generating module 2 is configured to be disposed at a predetermined position adjacent to the light providing module 1 (that is to say, the image generating module 2 is arranged on the optical path close to the light providing module 1), and the image generating module 2 is configured to allow the projection beam L1 to pass through (that is to say, the image generating module 2 is allowed to be passed by the projection beam L1), thereby converting the projection beam L1 into an image beam L2 (i.e., a light beam having an image signal) through the image generating module 2. For example, the image generating module 2 includes a transmissive LCD panel 210, and the transmissive LCD panel 210 can be allowed to be passed by the white light beam (i.e., the projection beam L1), thereby converting the white light beam into the image beam L2 through the transmissive LCD panel 210. However, the aforementioned details are disclosed for exemplary purposes only, and are not meant to limit the scope of the present disclosure.

Moreover, as shown in FIG. 1, the optical component module 3 is configured to be disposed at a predetermined position adjacent to the image generating module 2 (that is to say, the optical component module 3 is arranged on the optical path close to the image generating module 2). For example, the optical component module 3 at least includes a front collimator lens 311 (i.e., a front light-collimating lens) disposed between the light providing module 1 and the image generating module 2, a rear collimator lens 312 (i.e., a back light-collimating lens) disposed between the image generating module 2 and the projection lens module 4, and a condenser lens 321 (i.e., a light-condensing lens or any kind of light-concentrating component) disposed between the rear collimator lens 312 and the projection lens module 4. More particularly, the front collimator lens 311 can be configured to adjust an optical transmission path of the projection beam L1 that is generated by the light providing module 1, the rear collimator lens 312 can be configured to adjust an optical transmission path of the image beam L2 that is generated by the image generating module 2, and the condenser lens 321 can be configured to adjust a focusing position of the image beam L2 that has passed through the rear collimator lens 312 (that is to say, the condenser lens 321 can be configured to focus the image beam L2 that has passed through the rear collimator lens 312 on the projection lens module 4). However, the aforementioned details are disclosed for exemplary purposes only, and are not meant to limit the scope of the present disclosure.

In addition, as shown in FIG. 1, the projection lens module 4 is configured to be disposed at a predetermined position adjacent to the optical component module 3 (that is to say, the projection lens module 4 is arranged on the optical path close to the optical component module 3), and the projection lens module 4 can be configured to project the image beam L2 to a predetermined position. For example, the projection lens module 4 includes a lens assembly 400 that may be composed of a plurality of lenses, and the lens assembly 400 can be configured to convert the image beam L2 that has passed through the condenser lens 321 (or the image beam L2 formed by focusing through the condenser lens 321) into a projection image L3 projected on a predetermined screen C (or a plane image displayed on a predetermined screen C). However, the aforementioned details are disclosed for exemplary purposes only, and are not meant to limit the scope of the present disclosure.

Therefore, as shown in FIG. 1, the light providing module 1, the image generating module 2, the optical component module 3 and the projection lens module 4 can cooperate with each other to form an LCD projector using a single LCD panel (or a transmissive LCD projector using a single LCD panel).

### Second Embodiment

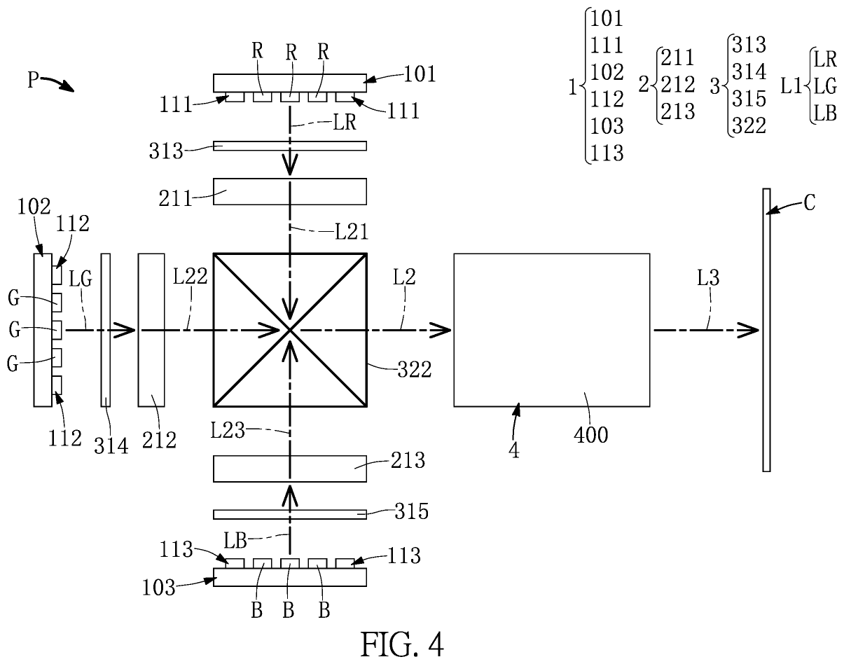

Referring to FIG. 4, a second embodiment of the present disclosure provides a digital projector P for generating projected images through timing control, which includes a light providing module 1, an image generating module 2, an optical component module 3 and a projection lens module 4, and the light providing module 1, the image generating module 2, the optical component module 3 and the projection lens module 4 can be configured to be disposed on a same optical path. Comparing FIG. 4 with FIG. 1, the main difference between the second embodiment and the first embodiment is as follows: in the second embodiment, the light-emitting chip units 110 can be divided into a plurality of first light-emitting chip units 111, a plurality of second light-emitting chip units 112 and a plurality of third light-emitting chip units 113.

For example, as shown in FIG. 4, the light providing module 1 includes a first circuit substrate 101 having a first timing control circuit, a second circuit substrate 102 having a second timing control circuit, and a third circuit substrate 103 having a third timing control circuit, the first timing control circuit of the first circuit substrate 101, the second timing control circuit of the second circuit substrate 102, and the third timing control circuit of the third circuit substrate 103 can be configured to provide a same timing control (i.e., the same timing control signal) within the predetermined time, thereby synchronously controlling the first light-emitting chip units 111, the second light-emitting chip units 112 and the third light-emitting chip units 113. However, the aforementioned details are disclosed for exemplary purposes only, and are not meant to limit the scope of the present disclosure.

For example, as shown in FIG. 4, the first light-emitting chip units 111 can be disposed on the first circuit substrate 101 in a predetermined arrangement shape (such as an array shape or a matrix shape) and electrically connected to the first circuit substrate 101, and the first light-emitting chip units 111 are configured to be not turned on simultaneously (for example, the first light-emitting chip units 111 can be configured to be turned on sequentially to present a plurality of point light sources or a plurality of line light sources), thereby reducing heat transmitted from the first light-emitting chip units 111 to the first circuit substrate 101 (it is worth noting that the first circuit substrate 101 can also be equipped with a heat sink to improve the heat dissipation effect). Moreover, the second light-emitting chip units 112 can be disposed on the second circuit substrate 102 in a predetermined arrangement shape (such as an array shape or a matrix shape) and electrically connected to the second circuit substrate 102, and the second light-emitting chip units 112 are configured to be not turned on simultaneously (for example, the second light-emitting chip units 112 can be configured to be turned on sequentially to present a plurality of point light sources or a plurality of line light sources), thereby reducing heat transmitted from the second light-emitting chip units 112 to the second circuit substrate 102 (it is worth noting that the second circuit substrate 102 can also be equipped with a heat sink to improve the heat dissipation effect). In addition, the third light-emitting chip units 113 can be disposed on the third circuit substrate 103 in a predetermined arrangement shape (such as an array shape or a matrix shape) and electrically connected to the third circuit substrate 103, and the third light-emitting chip units 113 are configured to be not turned on simultaneously (for example, the third light-emitting chip units 113 can be configured to be turned on sequentially to present a plurality of point light sources or a plurality of line light sources), thereby reducing heat transmitted from the third light-emitting chip units 113 to the third circuit substrate 103 (it is worth noting that the third circuit substrate 103 can also be equipped with a heat sink to improve the heat dissipation effect). However, the aforementioned details are disclosed for exemplary purposes only, and are not meant to limit the scope of the present disclosure.

For example, as shown in FIG. 4, each of the first light-emitting chip units 111 includes a red light-emitting chip R configured to generate a red light beam LR, each of the second light-emitting chip units 112 includes a green light-emitting chip G configured to generate a green light beam LG, each of the third light-emitting chip units 113 includes a blue light-emitting chip B configured to generate a blue light beam LB, and the red light-emitting chips R of the first light-emitting chip units 111, the green light-emitting chips G of the third light-emitting chip units 113 and the blue light-emitting chips B of the third light-emitting chip unit can be turned on through the same timing control within the predetermined time (for example, the red light-emitting chip R provided on the first circuit substrate 101, the green light-emitting chip G provided on the second circuit substrate 102, and the blue light-emitting chip B provided on the third circuit substrate 103 can be turned on simultaneously to present three point light sources at the same time), thereby enabling the light providing module 1 to generate the projection beam L1. More particularly, the red light beam LR generated by the red light-emitting chip R (or a red surface light source provided by the cooperation of the red light beams LR generated by the red light-emitting chips R), the green light beam LG generated by the green light-emitting chip G (or a green surface light source provided by the cooperation of the green light beams LG generated by the green light-emitting chips G) and the blue light beam LB generated by the blue light-emitting chip B (or a blue surface light source provided by the cooperation of the blue light beams LB generated by the blue light-emitting chips B) can cooperate with each other to form a white light beam generated by each of the light-emitting chip units 110, and the red light-emitting chip R, the green light-emitting chip G and the blue light-emitting chip B provided by each of the light-emitting chip units 110 may all be LED chips or laser diode chips. However, the aforementioned details are disclosed for exemplary purposes only, and are not meant to limit the scope of the present disclosure.

For example, as shown in FIG. 4, the image generating module 2 includes a first transmissive LCD panel 211, a second transmissive LCD panel 212 and a third transmissive LCD panel 213. More particularly, the first transmissive LCD panel 211 can be allowed to be passed by the red light beam LR, thereby converting the red light beam LR into a first image light beam L21 through the first transmissive LCD panel 211. Moreover, the second transmissive LCD panel 212 can be allowed to be passed by the green light beam LG, thereby converting the green light beam LG into a second image light beam L22 through the second transmissive LCD panel 212. In addition, the third transmissive LCD panel 213 can be allowed to be passed by the blue light beam LB, thereby converting the blue light beam LB into a third image light beam L23 through the third transmissive LCD panel 213. However, the aforementioned details are disclosed for exemplary purposes only, and are not meant to limit the scope of the present disclosure.

For example, as shown in FIG. 4, the optical component module 3 at least includes a first collimator lens 313 disposed between the first light-emitting chip units 111 of the light providing module 1 and the first transmissive LCD panel 211 of the image generating module 2, a second collimator lens 314 disposed between the second light-emitting chip units 112 of the light providing module 1 and the second transmissive LCD panel 212 of the image generating module 2, a third collimator lens 315 disposed between the third light-emitting chip units 113 of the light providing module 1 and the third transmissive LCD panel 213 of the image generating module 2, and a light-combining prism 322 (or any kind of light-combining component such as an X-cube or a trichroic prism) disposed between the first transmissive LCD panel 211, the second transmissive LCD panel 212, the third transmissive LCD panel 213 and the projection lens module 4, and the projection lens module 4 includes a lens assembly 400 that may be composed of a plurality of lenses. More particularly, the first collimator lens 313 can be configured to adjust a first optical transmission path of the red light beam LR generated by each of the red light-emitting chips R, the second collimator lens 314 can be configured to adjust a second optical transmission path of the green light beam LG generated by each of the green light-emitting chips G, and the third collimator lens 315 can be configured to adjust a third optical transmission path of the blue light beam LB generated by each of the blue light-emitting chips B. Moreover, the light-combining prism 322 can be configured to collect (or receive) the first image beam L21 generated by the first transmissive LCD panel 211, the second image beam L22 generated by the second transmissive LCD panel 212, and the third image beam L23 generated by the third transmissive LCD panel 213, thereby generating the image beam L2 projected to the projection lens module 4. In addition, the lens assembly 400 can be configured to convert the image beam L2 that is collected through the light-combining prism 322 into a projection image L3 projected on a predetermined screen C (or a plane image displayed on a predetermined screen C). However, the aforementioned details are disclosed for exemplary purposes only, and are not meant to limit the scope of the present disclosure.

Therefore, as shown in FIG. 4, the light providing module 1, the image generating module 2, the optical component module 3 and the projection lens module 4 can cooperate with each other to form an LCD projector using three LCD panels (or a transmissive LCD projector using three LCD panels).

### Third Embodiment

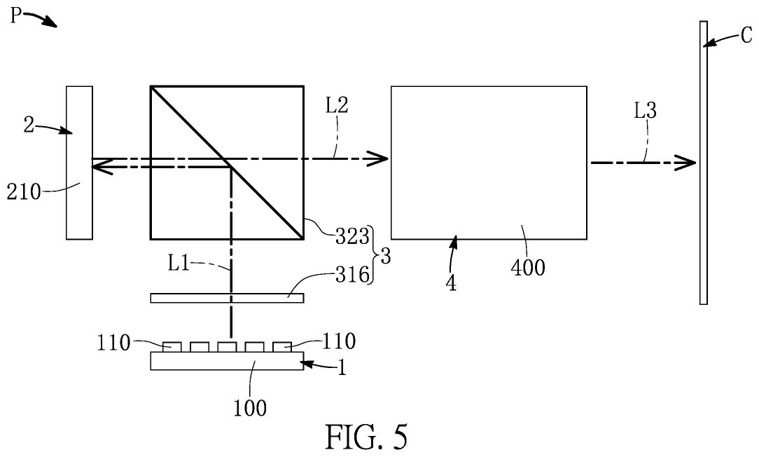

Referring to FIG. 5, a third embodiment of the present disclosure provides a digital projector P for generating projected images through timing control, which includes a light providing module 1 (or a light generating module), an image generating module 2 (or an image providing module), an optical component module 3 and a projection lens module 4, and the light providing module 1, the image generating module 2, the optical component module 3 and the projection lens module 4 can be configured to be disposed on a same optical path. It is worth noting that, in order to facilitate the description of the present disclosure, the outer casing of the digital projector P is omitted in the drawings.

Firstly, referring to FIG. 5, the light providing module 1 includes a plurality of light-emitting chip units 110, and the light-emitting chip units 110 of the light providing module 1 can be configured to be turned on asynchronously within a predetermined time through timing control (or sequential control), thereby enabling the light providing module 1 to generate a projection beam L1 (or a projection light source). For example, the light-emitting chip units 110 of the light providing module 1 can be configured to be turned on sequentially to present a plurality of point light sources (i.e., each point light source is generated by a single light-emitting chip unit 110) or a plurality of line light sources (i.e., each line light source is generated by a plurality of light-emitting chip units 110 arranged in a row), so that neither the point light source nor the line light source will be turned on at the same time. Moreover, the light providing module 1 further includes a circuit substrate 100 having a timing control circuit (i.e., a circuit layout for providing timing control), the light-emitting chip units 110 can be disposed on the circuit substrate 100 in a predetermined arrangement shape (such as an array shape or a matrix shape) and electrically connected to the circuit substrate 100, and the light-emitting chip units 110 are configured to be not turned on simultaneously, thereby reducing heat transmitted from the light-emitting chip units 110 to the circuit substrate 100. It is worth noting that the circuit substrate 100 can also be equipped with a heat sink to improve the heat dissipation effect. However, the aforementioned details are disclosed for exemplary purposes only, and are not meant to limit the scope of the present disclosure.

For example, each of the light-emitting chip units 110 can be a multi-chip structure or a single-chip structure. More particularly, as shown in FIG. 2, when each of the light-emitting chip units 110 is a multi-chip structure, each of the light-emitting chip units 110 includes a red light-emitting chip R configured to generate a red light beam LR, a green light-emitting chip G configured to generate a green light beam LG, and a blue light-emitting chip B configured to generate a blue light beam LB, the red light beam LR generated by the red light-emitting chip R, the green light beam LG generated by the green light-emitting chip G, and the blue light-emitting chip B generated by the blue light-emitting chip B can cooperate with each other to form a white light beam that is provided by each of the light-emitting chip units 110, and the red light-emitting chips R, the green light-emitting chips G and the blue light-emitting chips B provided by each of the light-emitting chip units 110 may all be light-emitting diode chips (i.e., LED chips) or laser diode chips (i.e., LD chips). In addition, as shown in FIG. 3, when each of the light-emitting chip units 110 is a single-chip structure, each of the light-emitting chip units 110 includes a blue light-emitting chip B and a phosphor layer Y for covering the blue light-emitting chip B, the blue light beam (not shown in figures) generated by the blue light-emitting chip B can pass through the phosphor layer Y to form a white light beam that is provided by each of the light-emitting chip units 110, and the blue light-emitting chip B provided by each of the light-emitting chip units 110 can be an LED chip or an LD chip. However, the aforementioned details are disclosed for exemplary purposes only, and are not meant to limit the scope of the present disclosure.

Furthermore, as shown in FIG. 5, the image generating module 2 is configured to be disposed at a predetermined position adjacent to the light providing module 1 (that is to say, the image generating module 2 is arranged on the optical path close to the light providing module 1), and the image generating module 2 is configured to reflect the projection beam L1, thereby converting the projection beam L1 into an image beam L2 (i.e., a light beam having an image signal) through the image generating module 2. For example, the image generating module 2 includes a reflective LCD panel 220, and the reflective LCD panel 220 can be configured to reflect the white light beam (i.e., the projection beam L1), thereby converting the white light beam into the image beam L2 through the reflective LCD panel 220. However, the aforementioned details are disclosed for exemplary purposes only, and are not meant to limit the scope of the present disclosure.

Moreover, as shown in FIG. 5, the optical component module 3 is configured to be disposed at a predetermined position adjacent to the image generating module 2 (that is to say, the optical component module 3 is arranged on the optical path close to the image generating module 2). For example, the optical component module 3 at least includes a light-splitting prism 323 (or any kind of light-splitting component) disposed between the light providing module 1, the image generating module 2 and the projection lens module 4, and an optical collimator lens 316 (i.e., an optical light-collimating lens) disposed between the light providing module 1 and the light-splitting prism 323. More particularly, the optical collimator lens 316 can be configured to adjust an optical transmission path of the projection beam L1 generated by the light providing module 1, the light-splitting prism 323 can be configured to reflect the projection beam L1 generated by the light providing module 1 onto the image generating module 2, and the light-splitting prism 323 can be configured to guide the image beam L2 generated by the image generating module 2 to the projection lens module 4. However, the aforementioned details are disclosed for exemplary purposes only, and are not meant to limit the scope of the present disclosure.

In addition, as shown in FIG. 5, the projection lens module 4 is configured to be disposed at a predetermined position adjacent to the optical component module 3 (that is to say, the projection lens module 4 is arranged on the optical path close to the optical component module 3), and the projection lens module 4 can be configured to project the image beam L2 to a predetermined position. For example, the projection lens module 4 includes a lens assembly 400 that may be composed of a plurality of lenses, and the lens assembly 400 can be configured to convert the image beam L2 that has passed through the light-splitting prism 323 (or the image beam L2 formed by guiding through the light-splitting prism 323) into a projection image L3 projected on a predetermined screen C (or a plane image displayed on a predetermined screen C). However, the aforementioned details are disclosed for exemplary purposes only, and are not meant to limit the scope of the present disclosure.

Therefore, as shown in FIG. 1, the light providing module 1, the image generating module 2, the optical component module 3 and the projection lens module 4 can cooperate with each other to form an LCoS (Liquid Crystal on Silicon) projector using a single LCoS panel (or a reflective LCD projector using a single reflective LCD panel).

### Fourth Embodiment

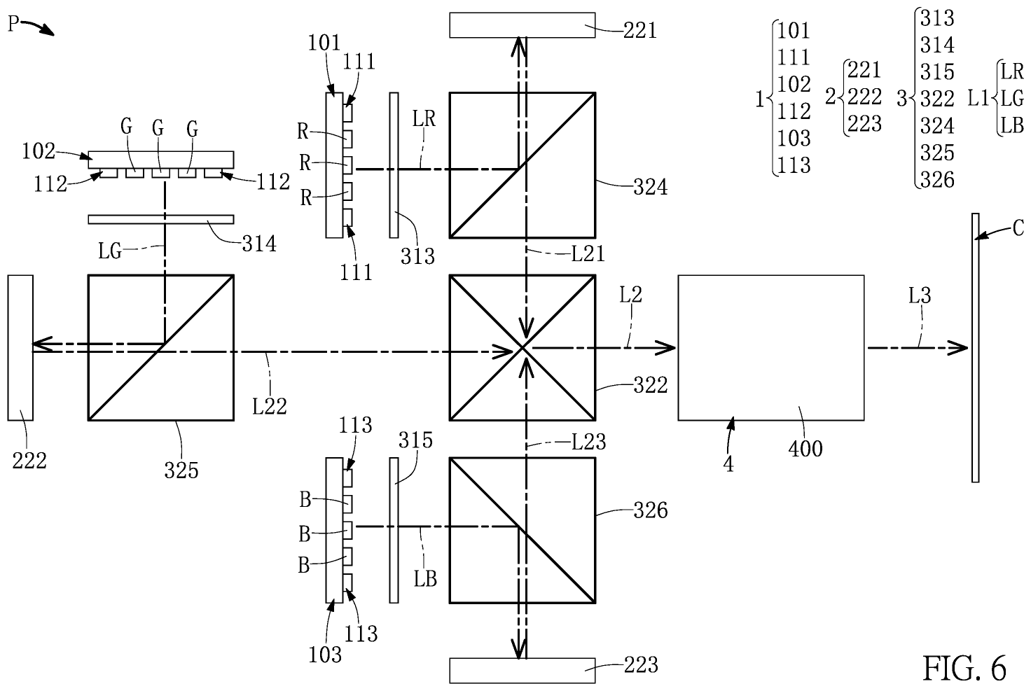

Referring to FIG. 6, a fourth embodiment of the present disclosure provides a digital projector P for generating projected images through timing control, which includes a light providing module 1, an image generating module 2, an optical component module 3 and a projection lens module 4, and the light providing module 1, the image generating module 2, the optical component module 3 and the projection lens module 4 can be configured to be disposed on a same optical path. Comparing FIG. 6 with FIG. 5, the main difference between the fourth embodiment and the third embodiment is as follows: in the fourth embodiment, the light-emitting chip units 110 can be divided into a plurality of first light-emitting chip units 111, a plurality of second light-emitting chip units 112 and a plurality of third light-emitting chip units 113.

For example, as shown in FIG. 6, the light providing module 1 includes a first circuit substrate 101 having a first timing control circuit, a second circuit substrate 102 having a second timing control circuit, and a third circuit substrate 103 having a third timing control circuit, the first timing control circuit of the first circuit substrate 101, the second timing control circuit of the second circuit substrate 102, and the third timing control circuit of the third circuit substrate 103 can be configured to provide a same timing control (i.e., the same timing control signal) within the predetermined time, thereby synchronously controlling the first light-emitting chip units 111, the second light-emitting chip units 112 and the third light-emitting chip units 113. However, the aforementioned details are disclosed for exemplary purposes only, and are not meant to limit the scope of the present disclosure.

For example, as shown in FIG. 6, the first light-emitting chip units 111 can be disposed on the first circuit substrate 101 in a predetermined arrangement shape (such as an array shape or a matrix shape) and electrically connected to the first circuit substrate 101, and the first light-emitting chip units 111 are configured to be not turned on simultaneously (for example, the first light-emitting chip units 111 can be configured to be turned on sequentially to present a plurality of point light sources or a plurality of line light sources), thereby reducing heat transmitted from the first light-emitting chip units 111 to the first circuit substrate 101 (it is worth noting that the first circuit substrate 101 can also be equipped with a heat sink to improve the heat dissipation effect). Moreover, the second light-emitting chip units 112 can be disposed on the second circuit substrate 102 in a predetermined arrangement shape (such as an array shape or a matrix shape) and electrically connected to the second circuit substrate 102, and the second light-emitting chip units 112 are configured to be not turned on simultaneously (for example, the second light-emitting chip units 112 can be configured to be turned on sequentially to present a plurality of point light sources or a plurality of line light sources), thereby reducing heat transmitted from the second light-emitting chip units 112 to the second circuit substrate 102 (it is worth noting that the second circuit substrate 102 can also be equipped with a heat sink to improve the heat dissipation effect). In addition, the third light-emitting chip units 113 can be disposed on the third circuit substrate 103 in a predetermined arrangement shape (such as an array shape or a matrix shape) and electrically connected to the third circuit substrate 103, and the third light-emitting chip units 113 are configured to be not turned on simultaneously (for example, the third light-emitting chip units 113 can be configured to be turned on sequentially to present a plurality of point light sources or a plurality of line light sources), thereby reducing heat transmitted from the third light-emitting chip units 113 to the third circuit substrate 103 (it is worth noting that the third circuit substrate 103 can also be equipped with a heat sink to improve the heat dissipation effect). However, the aforementioned details are disclosed for exemplary purposes only, and are not meant to limit the scope of the present disclosure.

For example, as shown in FIG. 6, each of the first light-emitting chip units 111 includes a red light-emitting chip R configured to generate a red light beam LR, each of the second light-emitting chip units 112 includes a green light-emitting chip G configured to generate a green light beam LG, each of the third light-emitting chip units 113 includes a blue light-emitting chip B configured to generate a blue light beam LB, and the red light-emitting chips R of the first light-emitting chip units 111, the green light-emitting chips G of the third light-emitting chip units 113 and the blue light-emitting chips B of the third light-emitting chip unit can be turned on through the same timing control within the predetermined time (for example, the red light-emitting chip R provided on the first circuit substrate 101, the green light-emitting chip G provided on the second circuit substrate 102, and the blue light-emitting chip B provided on the third circuit substrate 103 can be turned on simultaneously to present three point light sources at the same time), thereby enabling the light providing module 1 to generate the projection beam L1. More particularly, the red light beam LR generated by the red light-emitting chip R (or a red surface light source provided by the cooperation of the red light beams LR generated by the red light-emitting chips R), the green light beam LG generated by the green light-emitting chip G (or a green surface light source provided by the cooperation of the green light beams LG generated by the green light-emitting chips G) and the blue light beam LB generated by the blue light-emitting chip B (or a blue surface light source provided by the cooperation of the blue light beams LB generated by the blue light-emitting chips B) can cooperate with each other to form a white light beam generated by each of the light-emitting chip units 110, and the red light-emitting chip R, the green light-emitting chip G and the blue light-emitting chip B provided by each of the light-emitting chip units 110 may all be LED chips or laser diode chips. However, the aforementioned details are disclosed for exemplary purposes only, and are not meant to limit the scope of the present disclosure.

For example, as shown in FIG. 6, the image generating module 2 includes a first reflective LCD panel 221, a second reflective LCD panel 222 and a third reflective LCD panel 223. More particularly, the first reflective LCD panel 221 can be configured to reflect the red light beam LR, thereby converting the red light beam LR into a first image light beam L21 through the first reflective LCD panel 221. Moreover, the second reflective LCD panel 222 can be configured to reflect the green light beam LG, thereby converting the green light beam LG into a second image light beam L22 through the second reflective LCD panel 222. In addition, the third reflective LCD panel 223 can be configured to reflect the blue light beam LB, thereby converting the blue light beam LB into a third image light beam L23 through the third reflective LCD panel 223. However, the aforementioned details are disclosed for exemplary purposes only, and are not meant to limit the scope of the present disclosure.

For example, as shown in FIG. 6, the optical component module 3 at least includes a first light-splitting prism 324 disposed between the first light-emitting chip units 111 of the light providing module 1, the first reflective LCD panel 221 of the image generating module 2 and the projection lens module 4, a second light-splitting prism 325 disposed between the second light-emitting chip units 112 of the light providing module 1, the second reflective LCD panel 222 of the image generating module 2 and the projection lens module 4, a third light-splitting prism 326 disposed between the third light-emitting chip units 113 of the light providing module 1, the third reflective LCD panel 223 of the image generating module 2 and the projection lens module 4, and a light-combining prism 322 (or any kind of light-combining component such as an X-cube or a trichroic prism) disposed between the first light-splitting prism 324, the second light-splitting prism 325 and the third light-splitting prism 326. In addition, the optical component module 3 at least includes a first collimator lens 313 disposed between the first light-emitting chip units 111 of the light providing module 1 and the first light-splitting prism 324, a second collimator lens 314 disposed between the second light-emitting chip units 112 of the light providing module 1 and the second light-splitting prism 325, and a third collimator lens 315 disposed between the third light-emitting chip units 113 of the light providing module 1 and the third light-splitting prism 326. However, the aforementioned details are disclosed for exemplary purposes only, and are not meant to limit the scope of the present disclosure.

For example, as shown in FIG. 6, the first collimator lens 313 can be configured to adjust a first optical transmission path of the red light beam LR generated by each of the red light-emitting chips R, the second collimator lens 314 can be configured to adjust a second optical transmission path of the green light beam LG generated by each of the green light-emitting chips G, and the third collimator lens 315 can be configured to adjust a third optical transmission path of the blue light beam LB generated by each of the blue light-emitting chips B. Furthermore, the first light-splitting prism 324 can be configured to reflect the red light beam LR generated by each of the red light-emitting chips R onto the first reflective LCD panel 221, the second light-splitting prism 325 can be configured to reflect the green light beam LG generated by each of the green light-emitting chips G onto the second reflective LCD panel 222, and the third light-splitting prism 326 can be configured to reflect the blue light beam LB generated by each of the blue light-emitting chips B onto the third reflective LCD panel 223. Moreover, the first light-splitting prism 324 can be configured to guide the first image beam L21 generated by the first reflective LCD panel 221 to the light-combining prism 322, the second light-splitting prism 325 can be configured to guide the second image beam L22 generated by the second reflective LCD panel 222 to the light-combining prism 322, and the third light-splitting prism 326 can be configured to guide the third image beam L23 generated by the third reflective LCD panel 223 to the light-combining prism 322. In addition, the light-combining prism 322 can be configured to collect (or receive) the first image beam L21 generated by the first reflective LCD panel 221, the second image beam L22 generated by the second reflective LCD panel 222, and the third image beam L23 generated by the third reflective LCD panel 223, thereby generating the image beam L2 projected to the projection lens module 4. However, the aforementioned details are disclosed for exemplary purposes only, and are not meant to limit the scope of the present disclosure.

For example, as shown in FIG. 6, the projection lens module 4 includes a lens assembly 400 that may be composed of a plurality of lenses, and the lens assembly 400 can be configured to convert the image beam L2 that is collected through the light-combining prism 322 into a projection image L3 projected on a predetermined screen C (or a plane image displayed on a predetermined screen C).

Therefore, as shown in FIG. 4, the light providing module 1, the image generating module 2, the optical component module 3 and the projection lens module 4 can cooperate with each other to form an LCoS projector using three LCoS panels (or a reflective LCD projector using three reflective LCD panels).

### Fifth Embodiment

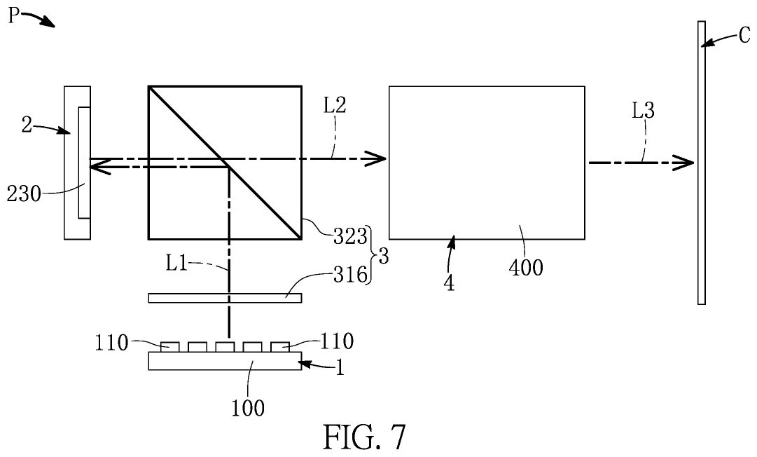

Referring to FIG. 7, a fifth embodiment of the present disclosure provides a digital projector P for generating projected images through timing control, which includes a light providing module 1, an image generating module 2, an optical component module 3 and a projection lens module 4, and the light providing module 1, the image generating module 2, the optical component module 3 and the projection lens module 4 can be configured to be disposed on a same optical path. Comparing FIG. 7 with FIG. 5, the main difference between the fifth embodiment and the third embodiment is as follows: in the fifth embodiment, the image generating module 2 includes a digital micromirror chip 230 (or a DMD chip) having a plurality of micro mirrors, and the digital micromirror chip 230 can be configured to reflect a projection beam L1 (i.e., a white light beam), thereby converting the projection beam L1 into an image beam L2. Therefore, the light providing module 1, the image generating module 2, the optical component module 3 and the projection lens module 4 can cooperate with each other to form a DLP (Digital Light Processing) projector using a single DMD chip (or a fully digital reflective projector using a single DMD chip).

### Sixth Embodiment

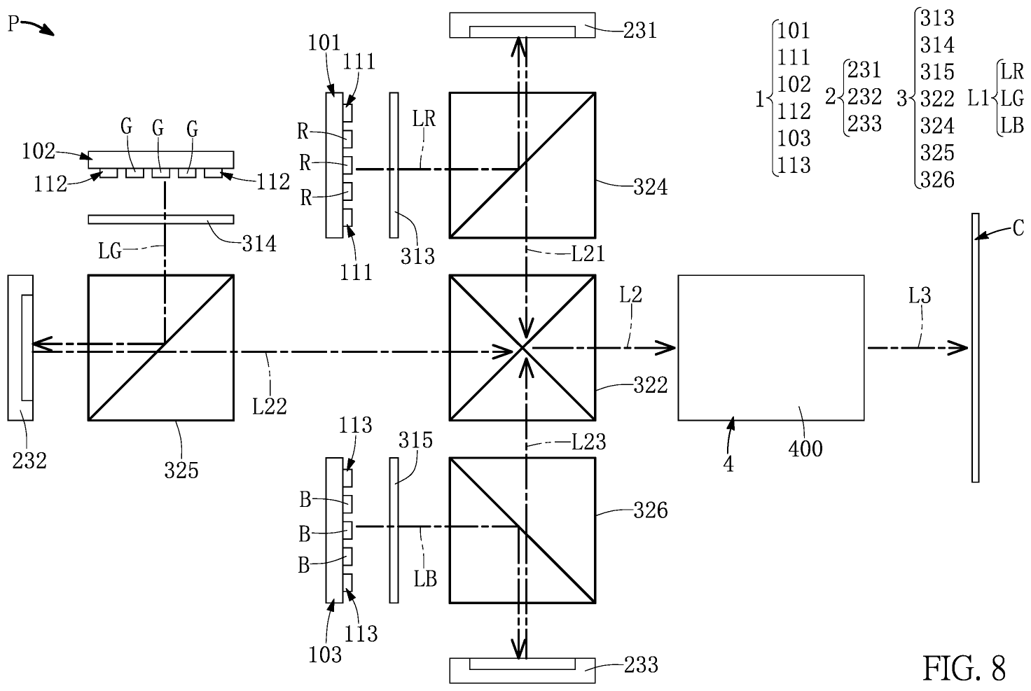

Referring to FIG. 8, a sixth embodiment of the present disclosure provides a digital projector P for generating projected images through timing control, which includes a light providing module 1, an image generating module 2, an optical component module 3 and a projection lens module 4, and the light providing module 1, the image generating module 2, the optical component module 3 and the projection lens module 4 can be configured to be disposed on a same optical path. Comparing FIG. 8 with FIG. 7, the main difference between the sixth embodiment and the fifth embodiment is as follows: in the sixth embodiment, the light-emitting chip units 110 can be divided into a plurality of first light-emitting chip units 111, a plurality of second light-emitting chip units 112 and a plurality of third light-emitting chip units 113.

For example, as shown in FIG. 8, the light providing module 1 includes a first circuit substrate 101 having a first timing control circuit, a second circuit substrate 102 having a second timing control circuit, and a third circuit substrate 103 having a third timing control circuit, the first timing control circuit of the first circuit substrate 101, the second timing control circuit of the second circuit substrate 102, and the third timing control circuit of the third circuit substrate 103 can be configured to provide a same timing control (i.e., the same timing control signal) within the predetermined time, thereby synchronously controlling the first light-emitting chip units 111, the second light-emitting chip units 112 and the third light-emitting chip units 113. However, the aforementioned details are disclosed for exemplary purposes only, and are not meant to limit the scope of the present disclosure.

For example, as shown in FIG. 8, the first light-emitting chip units 111 can be disposed on the first circuit substrate 101 in a predetermined arrangement shape (such as an array shape or a matrix shape) and electrically connected to the first circuit substrate 101, and the first light-emitting chip units 111 are configured to be not turned on simultaneously (for example, the first light-emitting chip units 111 can be configured to be turned on sequentially to present a plurality of point light sources or a plurality of line light sources), thereby reducing heat transmitted from the first light-emitting chip units 111 to the first circuit substrate 101 (it is worth noting that the first circuit substrate 101 can also be equipped with a heat sink to improve the heat dissipation effect). Moreover, the second light-emitting chip units 112 can be disposed on the second circuit substrate 102 in a predetermined arrangement shape (such as an array shape or a matrix shape) and electrically connected to the second circuit substrate 102, and the second light-emitting chip units 112 are configured to be not turned on simultaneously (for example, the second light-emitting chip units 112 can be configured to be turned on sequentially to present a plurality of point light sources or a plurality of line light sources), thereby reducing heat transmitted from the second light-emitting chip units 112 to the second circuit substrate 102 (it is worth noting that the second circuit substrate 102 can also be equipped with a heat sink to improve the heat dissipation effect). In addition, the third light-emitting chip units 113 can be disposed on the third circuit substrate 103 in a predetermined arrangement shape (such as an array shape or a matrix shape) and electrically connected to the third circuit substrate 103, and the third light-emitting chip units 113 are configured to be not turned on simultaneously (for example, the third light-emitting chip units 113 can be configured to be turned on sequentially to present a plurality of point light sources or a plurality of line light sources), thereby reducing heat transmitted from the third light-emitting chip units 113 to the third circuit substrate 103 (it is worth noting that the third circuit substrate 103 can also be equipped with a heat sink to improve the heat dissipation effect). However, the aforementioned details are disclosed for exemplary purposes only, and are not meant to limit the scope of the present disclosure.

For example, as shown in FIG. 8, each of the first light-emitting chip units 111 includes a red light-emitting chip R configured to generate a red light beam LR, each of the second light-emitting chip units 112 includes a green light-emitting chip G configured to generate a green light beam LG, each of the third light-emitting chip units 113 includes a blue light-emitting chip B configured to generate a blue light beam LB, and the red light-emitting chips R of the first light-emitting chip units 111, the green light-emitting chips G of the third light-emitting chip units 113 and the blue light-emitting chips B of the third light-emitting chip unit can be turned on through the same timing control within the predetermined time (for example, the red light-emitting chip R provided on the first circuit substrate 101, the green light-emitting chip G provided on the second circuit substrate 102, and the blue light-emitting chip B provided on the third circuit substrate 103 can be turned on simultaneously to present three point light sources at the same time), thereby enabling the light providing module 1 to generate the projection beam L1. More particularly, the red light beam LR generated by the red light-emitting chip R (or a red surface light source provided by the cooperation of the red light beams LR generated by the red light-emitting chips R), the green light beam LG generated by the green light-emitting chip G (or a green surface light source provided by the cooperation of the green light beams LG generated by the green light-emitting chips G) and the blue light beam LB generated by the blue light-emitting chip B (or a blue surface light source provided by the cooperation of the blue light beams LB generated by the blue light-emitting chips B) can cooperate with each other to form a white light beam generated by each of the light-emitting chip units 110, and the red light-emitting chip R, the green light-emitting chip G and the blue light-emitting chip B provided by each of the light-emitting chip units 110 may all be LED chips or laser diode chips. However, the aforementioned details are disclosed for exemplary purposes only, and are not meant to limit the scope of the present disclosure.

For example, as shown in FIG. 8, the image generating module 2 includes a first digital micromirror chip 231, a second digital micromirror chip 232 and a third digital micromirror chip 233. More particularly, the first digital micromirror chip 231 can be configured to reflect the red light beam LR, thereby converting the red light beam LR into a first image light beam L21 through the first digital micromirror chip 231. Moreover, the second digital micromirror chip 232 can be configured to reflect the green light beam LG, thereby converting the green light beam LG into a second image light beam L22 through the second digital micromirror chip 232. In addition, the third digital micromirror chip 233 can be configured to reflect the blue light beam LB, thereby converting the blue light beam LB into a third image light beam L23 through the third digital micromirror chip 233. However, the aforementioned details are disclosed for exemplary purposes only, and are not meant to limit the scope of the present disclosure.

For example, as shown in FIG. 8, the optical component module 3 at least includes a first light-splitting prism 324 disposed between the first light-emitting chip units 111 of the light providing module 1, the first digital micromirror chip 231 of the image generating module 2 and the projection lens module 4, a second light-splitting prism 325 disposed between the second light-emitting chip units 112 of the light providing module 1, the second digital micromirror chip 232 of the image generating module 2 and the projection lens module 4, a third light-splitting prism 326 disposed between the third light-emitting chip units 113 of the light providing module 1, the third digital micromirror chip 233 of the image generating module 2 and the projection lens module 4, and a light-combining prism 322 (or any kind of light-combining component such as an X-cube or a trichroic prism) disposed between the first light-splitting prism 324, the second light-splitting prism 325 and the third light-splitting prism 326. In addition, the optical component module 3 at least includes a first collimator lens 313 disposed between the first light-emitting chip units 111 of the light providing module 1 and the first light-splitting prism 324, a second collimator lens 314 disposed between the second light-emitting chip units 112 of the light providing module 1 and the second light-splitting prism 325, and a third collimator lens 315 disposed between the third light-emitting chip units 113 of the light providing module 1 and the third light-splitting prism 326. However, the aforementioned details are disclosed for exemplary purposes only, and are not meant to limit the scope of the present disclosure.

For example, as shown in FIG. 8, the first collimator lens 313 can be configured to adjust a first optical transmission path of the red light beam LR generated by each of the red light-emitting chips R, the second collimator lens 314 can be configured to adjust a second optical transmission path of the green light beam LG generated by each of the green light-emitting chips G, and the third collimator lens 315 can be configured to adjust a third optical transmission path of the blue light beam LB generated by each of the blue light-emitting chips B. Furthermore, the first light-splitting prism 324 can be configured to reflect the red light beam LR generated by each of the red light-emitting chips R onto the first digital micromirror chip 231, the second light-splitting prism 325 can be configured to reflect the green light beam LG generated by each of the green light-emitting chips G onto the second digital micromirror chip 232, and the third light-splitting prism 326 can be configured to reflect the blue light beam LB generated by each of the blue light-emitting chips B onto the third digital micromirror chip 233. Moreover, the first light-splitting prism 324 can be configured to guide the first image beam L21 generated by the first digital micromirror chip 231 to the light-combining prism 322, the second light-splitting prism 325 can be configured to guide the second image beam L22 generated by the second digital micromirror chip 232 to the light-combining prism 322, and the third light-splitting prism 326 can be configured to guide the third image beam L23 generated by the third digital micromirror chip 233 to the light-combining prism 322. In addition, the light-combining prism 322 can be configured to collect (or receive) the first image beam L21 generated by the first digital micromirror chip 231, the second image beam L22 generated by the second digital micromirror chip 232, and the third image beam L23 generated by the third digital micromirror chip 233, thereby generating the image beam L2 projected to the projection lens module 4. However, the aforementioned details are disclosed for exemplary purposes only, and are not meant to limit the scope of the present disclosure.

For example, as shown in FIG. 8, the projection lens module 4 includes a lens assembly 400 that may be composed of a plurality of lenses, and the lens assembly 400 can be configured to convert the image beam L2 that is collected through the light-combining prism 322 into a projection image L3 projected on a predetermined screen C (or a plane image displayed on a predetermined screen C).

Therefore, as shown in FIG. 8, the light providing module 1, the image generating module 2, the optical component module 3 and the projection lens module 4 can cooperate with each other to form a DLP projector using three DMD chips (or a fully digital reflective projector using three DMD chips).

### Beneficial Effects of the Embodiments

In conclusion, in the digital projector P for generating the projected images through timing control provided by the present disclosure, by virtue of “the light-emitting chip units 110 of the light providing module 1 being configured to be turned on asynchronously within a predetermined time through timing control, thereby enabling the light providing module 1 to generate a projection beam L1,” “the image generating module 2 being configured to allow the projection beam L1 to pass through, thereby converting the projection beam L1 into an image beam L2,” and “the projection lens module 4 being configured to project the image beam L2 to a predetermined position,” the digital projector P provided by the present disclosure can generate projected images in a sequential control manner (or a time-sequence controlled manner) through the cooperation of the light providing module 1, the image generating module 2, the optical component module 3 and the projection lens module 4.

Furthermore, in the digital projector P for generating the projected images through timing control provided by the present disclosure, by virtue of “the light-emitting chip units 110 of the light providing module 1 being configured to be turned on asynchronously within a predetermined time through timing control, thereby enabling the light providing module 1 to generate a projection beam L1,” “the image generating module 2 being configured to reflect the projection beam L1, thereby converting the projection beam L1 into an image beam L2,” and “the projection lens module 4 being configured to project the image beam L2 to a predetermined position,” the digital projector P provided by the present disclosure can generate projected images in a sequential control manner (or a time-sequence controlled manner) through the cooperation of the light providing module 1, the image generating module 2, the optical component module 3 and the projection lens module 4.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A digital projector for generating projected images through timing control, comprising:
a light providing module including a plurality of light-emitting chip units;
an image generating module configured to be disposed at a predetermined position adjacent to the light providing module;
an optical component module configured to be disposed at a predetermined position adjacent to the image generating module; and
a projection lens module configured to be disposed at a predetermined position adjacent to the optical component module;
wherein the light providing module, the image generating module, the optical component module and the projection lens module are configured to be disposed on a same optical path;
wherein the light-emitting chip units of the light providing module are configured to be turned on asynchronously within a predetermined time through timing control, thereby enabling the light providing module to generate a projection beam;
wherein the image generating module is configured to allow the projection beam to pass through, thereby converting the projection beam into an image beam;
wherein the projection lens module is configured to project the image beam to a predetermined position.

2. The digital projector according to claim 1,
wherein the light-emitting chip units of the light providing module are configured to be turned on sequentially to present a plurality of point light sources or a plurality of line light sources;
wherein the light providing module includes a circuit substrate having a timing control circuit, the light-emitting chip units are disposed on the circuit substrate in a predetermined arrangement shape and electrically connected to the circuit substrate, and the light-emitting chip units are configured to be not turned on simultaneously, thereby reducing heat transmitted from the light-emitting chip units to the circuit substrate;
wherein each of the light-emitting chip units is a multi-chip structure or a single-chip structure;
wherein, when each of the light-emitting chip units is the multi-chip structure, each of the light-emitting chip units includes a red light-emitting chip configured to generate a red light beam, a green light-emitting chip configured to generate a green light beam, and a blue light-emitting chip configured to generate a blue light beam, the red light beam generated by the red light-emitting chip, the green light beam generated by the green light-emitting chip, and the blue light-emitting chip generated by the blue light-emitting chip cooperate with each other to form a white light beam that is provided by each of the light-emitting chip units, and the red light-emitting chips, the green light-emitting chips and the blue light-emitting chips provided by each of the light-emitting chip units are all LED chips or laser diode chips;
wherein, when each of the light-emitting chip units is the single-chip structure, each of the light-emitting chip units includes a blue light-emitting chip and a phosphor layer for covering the blue light-emitting chip, the blue light beam generated by the blue light-emitting chip passes through the phosphor layer to form a white light beam that is provided by each of the light-emitting chip units, and the blue light-emitting chip provided by each of the light-emitting chip units is an LED chip or a laser diode chip;
wherein the image generating module includes a transmissive LCD panel, and the transmissive LCD panel is allowed to be passed by the white light beam, thereby converting the white light beam into the image beam;
wherein the optical component module includes a front collimator lens disposed between the light providing module and the image generating module, a rear collimator lens disposed between the image generating module and the projection lens module, and a condenser lens disposed between the rear collimator lens and the projection lens module;
wherein the front collimator lens is configured to adjust an optical transmission path of the projection beam generated by the light providing module;
wherein the rear collimator lens is configured to adjust an optical transmission path of the image beam generated by the image generating module;
wherein the condenser lens is configured to adjust a focusing position of the image beam passing through the rear collimator lens;
wherein the projection lens module includes a lens assembly, and the lens assembly is configured to convert the image beam passing through the condenser lens into a projection image projected on a predetermined screen;
wherein the light providing module, the image generating module, the optical component module and the projection lens module cooperate with each other to form an LCD projector using a single LCD panel.

3. The digital projector according to claim 1,
wherein the light-emitting chip units of the light providing module are configured to be turned on sequentially to present a plurality of point light sources or a plurality of line light sources;
wherein the light providing module includes a first circuit substrate having a first timing control circuit, a second circuit substrate having a second timing control circuit, and a third circuit substrate having a third timing control circuit, the first timing control circuit of the first circuit substrate, the second timing control circuit of the second circuit substrate, and the third timing control circuit of the third circuit substrate are configured to provide a same timing control within the predetermined time, and the light-emitting chip units are divided into a plurality of first light-emitting chip units, a plurality of second light-emitting chip units and a plurality of third light-emitting chip units;
wherein the first light-emitting chip units are disposed on the first circuit substrate in a predetermined arrangement shape and are electrically connected to the first circuit substrate, and the first light-emitting chip units are configured to be not turned on simultaneously, thereby reducing heat transmitted from the first light-emitting chip units to the first circuit substrate;
wherein the second light-emitting chip units are disposed on the second circuit substrate in a predetermined arrangement shape and are electrically connected to the second circuit substrate, and the second light-emitting chip units are configured to be not turned on simultaneously, thereby reducing heat transmitted from the second light-emitting chip units to the second circuit substrate;
wherein the third light-emitting chip units are disposed on the third circuit substrate in a predetermined arrangement shape and are electrically connected to the third circuit substrate, and the third light-emitting chip units are configured to be not turned on simultaneously, thereby reducing heat transmitted from the third light-emitting chip units to the third circuit substrate;
wherein each of the first light-emitting chip units includes a red light-emitting chip configured to generate a red light beam, each of the second light-emitting chip units includes a green light-emitting chip configured to generate a green light beam, each of the third light-emitting chip units includes a blue light-emitting chip configured to generate a blue light beam, and the red light-emitting chips of the first light-emitting chip units, the green light-emitting chips of the third light-emitting chip units and the blue light-emitting chips of the third light-emitting chip unit are turned on through the same timing control within the predetermined time, thereby enabling the light providing module to generate the projection beam;
wherein the red light beam generated by the red light-emitting chip, the green light beam generated by the green light-emitting chip and the blue light beam generated by the blue light-emitting chip cooperate with each other to form a white light beam generated by each of the light-emitting chip units, and the red light-emitting chip, the green light-emitting chip and the blue light-emitting chip provided by each of the light-emitting chip units are all LED chips or laser diode chips;
wherein the image generating module includes a first transmissive LCD panel, a second transmissive LCD panel and a third transmissive LCD panel;
wherein the first transmissive LCD panel is allowed to be passed by the red light beam, thereby converting the red light beam into a first image light beam;
wherein the second transmissive LCD panel is allowed to be passed by the green light beam, thereby converting the green light beam into a second image light beam;
wherein the third transmissive LCD panel is allowed to be passed by the blue light beam, thereby converting the blue light beam into a third image light beam;
wherein the optical component module includes a first collimator lens disposed between the first light-emitting chip units of the light providing module and the first transmissive LCD panel of the image generating module, a second collimator lens disposed between the second light-emitting chip units of the light providing module and the second transmissive LCD panel of the image generating module, a third collimator lens disposed between the third light-emitting chip units of the light providing module and the third transmissive LCD panel of the image generating module, and a light-combining prism disposed between the first transmissive LCD panel, the second transmissive LCD panel, the third transmissive LCD panel and the projection lens module;
wherein the first collimator lens is configured to adjust a first optical transmission path of the red light beam generated by each of the red light-emitting chips, the second collimator lens is configured to adjust a second optical transmission path of the green light beam generated by each of the green light-emitting chips, and the third collimator lens is configured to adjust a third optical transmission path of the blue light beam generated by each of the blue light-emitting chips;
wherein the light-combining prism is configured to collect the first image beam generated by the first transmissive LCD panel, the second image beam generated by the second transmissive LCD panel, and the third image beam generated by the third transmissive LCD panel, thereby generating the image beam projected to the projection lens module;
wherein the projection lens module includes a lens assembly, and the lens assembly is configured to convert the image beam collected through the light-combining prism into a projection image projected on a predetermined screen;
wherein the light providing module, the image generating module, the optical component module and the projection lens module cooperate with each other to form an LCD projector using three LCD panels.

4. A digital projector for generating projected images through timing control, comprising:
a light providing module including a plurality of light-emitting chip units;
an image generating module configured to be disposed at a predetermined position adjacent to the light providing module;
an optical component module configured to be disposed at a predetermined position adjacent to the image generating module; and
a projection lens module configured to be disposed at a predetermined position adjacent to the optical component module;
wherein the light providing module, the image generating module, the optical component module and the projection lens module are configured to be disposed on a same optical path;
wherein the light-emitting chip units of the light providing module are configured to be turned on asynchronously within a predetermined time through timing control, thereby enabling the light providing module to generate a projection beam;
wherein the image generating module is configured to reflect the projection beam, thereby converting the projection beam into an image beam;
wherein the projection lens module is configured to project the image beam to a predetermined position.

5. The digital projector according to claim 4,
wherein the light-emitting chip units of the light providing module are configured to be turned on sequentially to present a plurality of point light sources or a plurality of line light sources;
wherein the light providing module includes a circuit substrate having a timing control circuit, the light-emitting chip units are disposed on the circuit substrate in a predetermined arrangement shape and electrically connected to the circuit substrate, and the light-emitting chip units are configured to be not turned on simultaneously, thereby reducing heat transmitted from the light-emitting chip units to the circuit substrate;
wherein each of the light-emitting chip units is a multi-chip structure or a single-chip structure;
wherein, when each of the light-emitting chip units is the multi-chip structure, each of the light-emitting chip units includes a red light-emitting chip configured to generate a red light beam, a green light-emitting chip configured to generate a green light beam, and a blue light-emitting chip configured to generate a blue light beam, the red light beam generated by the red light-emitting chip, the green light beam generated by the green light-emitting chip, and the blue light-emitting chip generated by the blue light-emitting chip cooperate with each other to form a white light beam that is provided by each of the light-emitting chip units, and the red light-emitting chips, the green light-emitting chips and the blue light-emitting chips provided by each of the light-emitting chip units are all LED chips or laser diode chips;
wherein, when each of the light-emitting chip units is the single-chip structure, each of the light-emitting chip units includes a blue light-emitting chip and a phosphor layer for covering the blue light-emitting chip, the blue light beam generated by the blue light-emitting chip passes through the phosphor layer to form a white light beam that is provided by each of the light-emitting chip units, and the blue light-emitting chip provided by each of the light-emitting chip units is an LED chip or a laser diode chip;
wherein the image generating module includes a reflective LCD panel, and the reflective LCD panel is configured to reflect the white light beam, thereby converting the white light beam into the image beam;
wherein the optical component module includes a light-splitting prism disposed between the light providing module, the image generating module and the projection lens module, and an optical collimator lens disposed between the light providing module and the light-splitting prism;
wherein the optical collimator lens is configured to adjust an optical transmission path of the projection beam generated by the light providing module;
wherein the light-splitting prism is configured to reflect the projection beam generated by the light providing module onto the image generating module;
wherein the light-splitting prism is configured to guide the image beam generated by the image generating module to the projection lens module;
wherein the projection lens module includes a lens assembly, and the lens assembly is configured to convert the image beam passing through the light-splitting prism into a projection image projected on a predetermined screen;
wherein the light providing module, the image generating module, the optical component module and the projection lens module cooperate with each other to form an LCoS projector using a single LCoS panel.

6. The digital projector according to claim 4,
wherein the light-emitting chip units of the light providing module are configured to be turned on sequentially to present a plurality of point light sources or a plurality of line light sources;
wherein the light providing module includes a first circuit substrate having a first timing control circuit, a second circuit substrate having a second timing control circuit, and a third circuit substrate having a third timing control circuit, the first timing control circuit of the first circuit substrate, the second timing control circuit of the second circuit substrate, and the third timing control circuit of the third circuit substrate are configured to provide a same timing control within the predetermined time, and the light-emitting chip units are divided into a plurality of first light-emitting chip units, a plurality of second light-emitting chip units and a plurality of third light-emitting chip units;
wherein the first light-emitting chip units are disposed on the first circuit substrate in a predetermined arrangement shape and are electrically connected to the first circuit substrate, and the first light-emitting chip units are configured to be not turned on simultaneously, thereby reducing heat transmitted from the first light-emitting chip units to the first circuit substrate;
wherein the second light-emitting chip units are disposed on the second circuit substrate in a predetermined arrangement shape and are electrically connected to the second circuit substrate, and the second light-emitting chip units are configured to be not turned on simultaneously, thereby reducing heat transmitted from the second light-emitting chip units to the second circuit substrate;
wherein the third light-emitting chip units are disposed on the third circuit substrate in a predetermined arrangement shape and are electrically connected to the third circuit substrate, and the third light-emitting chip units are configured to be not turned on simultaneously, thereby reducing heat transmitted from the third light-emitting chip units to the third circuit substrate;
wherein each of the first light-emitting chip units includes a red light-emitting chip configured to generate a red light beam, each of the second light-emitting chip units includes a green light-emitting chip configured to generate a green light beam, each of the third light-emitting chip units includes a blue light-emitting chip configured to generate a blue light beam, and the red light-emitting chips of the first light-emitting chip units, the green light-emitting chips of the third light-emitting chip units and the blue light-emitting chips of the third light-emitting chip unit are turned on through the same timing control within the predetermined time, thereby enabling the light providing module to generate the projection beam;
wherein the red light beam generated by the red light-emitting chip, the green light beam generated by the green light-emitting chip and the blue light beam generated by the blue light-emitting chip cooperate with each other to form a white light beam generated by each of the light-emitting chip units, and the red light-emitting chip, the green light-emitting chip and the blue light-emitting chip provided by each of the light-emitting chip units are all LED chips or laser diode chips;
wherein the image generating module includes a first reflective LCD panel, a second reflective LCD panel and a third reflective LCD panel;
wherein the first reflective LCD panel is configured to reflect the red light beam, thereby converting the red light beam into a first image light beam;
wherein the second reflective LCD panel is configured to reflect the green light beam, thereby converting the green light beam into a second image light beam;
wherein the third reflective LCD panel is configured to reflect the blue light beam, thereby converting the blue light beam into a third image light beam;
wherein the optical component module includes a first light-splitting prism disposed between the first light-emitting chip units of the light providing module, the first reflective LCD panel of the image generating module and the projection lens module, a second light-splitting prism disposed between the second light-emitting chip units of the light providing module, the second reflective LCD panel of the image generating module and the projection lens module, a third light-splitting prism disposed between the third light-emitting chip units of the light providing module, the third reflective LCD panel of the image generating module and the projection lens module, and a light-combining prism disposed between the first light-splitting prism, the second light-splitting prism and the third light-splitting prism;
wherein the optical component module includes a first collimator lens disposed between the first light-emitting chip units of the light providing module and the first light-splitting prism, a second collimator lens disposed between the second light-emitting chip units of the light providing module and the second light-splitting prism, and a third collimator lens disposed between the third light-emitting chip units of the light providing module and the third light-splitting prism;
wherein the first collimator lens is configured to adjust a first optical transmission path of the red light beam generated by each of the red light-emitting chips, the second collimator lens is configured to adjust a second optical transmission path of the green light beam generated by each of the green light-emitting chips, and the third collimator lens is configured to adjust a third optical transmission path of the blue light beam generated by each of the blue light-emitting chips;
wherein the first light-splitting prism is configured to reflect the red light beam generated by each of the red light-emitting chips onto the first reflective LCD panel, the second light-splitting prism is configured to reflect the green light beam generated by each of the green light-emitting chips onto the second reflective LCD panel, and the third light-splitting prism is configured to reflect the blue light beam generated by each of the blue light-emitting chips onto the third reflective LCD panel;
wherein the first light-splitting prism is configured to guide the first image beam generated by the first reflective LCD panel to the light-combining prism, the second light-splitting prism is configured to guide the second image beam generated by the second reflective LCD panel to the light-combining prism, and the third light-splitting prism is configured to guide the third image beam generated by the third reflective LCD panel to the light-combining prism;
wherein the light-combining prism is configured to collect the first image beam generated by the first reflective LCD panel, the second image beam generated by the second reflective LCD panel, and the third image beam generated by the third reflective LCD panel, thereby generating the image beam projected to the projection lens module;
wherein the projection lens module includes a lens assembly, and the lens assembly is configured to convert the image beam collected through the light-combining prism into a projection image projected on a predetermined screen;
wherein the light providing module, the image generating module, the optical component module and the projection lens module cooperate with each other to form an LCoS projector using three LCoS panels.

7. The digital projector according to claim 4,
wherein the light-emitting chip units of the light providing module are configured to be turned on sequentially to present a plurality of point light sources or a plurality of line light sources;
wherein the light providing module includes a circuit substrate having a timing control circuit, the light-emitting chip units are disposed on the circuit substrate in a predetermined arrangement shape and electrically connected to the circuit substrate, and the light-emitting chip units are configured to be not turned on simultaneously, thereby reducing heat transmitted from the light-emitting chip units to the circuit substrate;
wherein each of the light-emitting chip units is a multi-chip structure or a single-chip structure;
wherein, when each of the light-emitting chip units is the multi-chip structure, each of the light-emitting chip units includes a red light-emitting chip configured to generate a red light beam, a green light-emitting chip configured to generate a green light beam, and a blue light-emitting chip configured to generate a blue light beam, the red light beam generated by the red light-emitting chip, the green light beam generated by the green light-emitting chip, and the blue light-emitting chip generated by the blue light-emitting chip cooperate with each other to form a white light beam that is provided by each of the light-emitting chip units, and the red light-emitting chips, the green light-emitting chips and the blue light-emitting chips provided by each of the light-emitting chip units are all LED chips or laser diode chips;
wherein, when each of the light-emitting chip units is the single-chip structure, each of the light-emitting chip units includes a blue light-emitting chip and a phosphor layer for covering the blue light-emitting chip, the blue light beam generated by the blue light-emitting chip passes through the phosphor layer to form a white light beam that is provided by each of the light-emitting chip units, and the blue light-emitting chip provided by each of the light-emitting chip units is an LED chip or a laser diode chip;
wherein the image generating module includes a digital micromirror chip, and the digital micromirror chip is configured to reflect the white light beam, thereby converting the white light beam into the image beam;
wherein the optical component module includes a light-splitting prism disposed between the light providing module, the image generating module and the projection lens module, and an optical collimator lens disposed between the light providing module and the light-splitting prism;
wherein the optical collimator lens is configured to adjust an optical transmission path of the projection beam generated by the light providing module;
wherein the light-splitting prism is configured to reflect the projection beam generated by the light providing module onto the image generating module;
wherein the light-splitting prism is configured to guide the image beam generated by the image generating module to the projection lens module;
wherein the projection lens module includes a lens assembly, and the lens assembly is configured to convert the image beam passing through the light-splitting prism into a projection image projected on a predetermined screen;
wherein the light providing module, the image generating module, the optical component module and the projection lens module cooperate with each other to form a DLP projector using a single DMD chip.

8. The digital projector according to claim 4,
wherein the light-emitting chip units of the light providing module are configured to be turned on sequentially to present a plurality of point light sources or a plurality of line light sources;
wherein the light providing module includes a first circuit substrate having a first timing control circuit, a second circuit substrate having a second timing control circuit, and a third circuit substrate having a third timing control circuit, the first timing control circuit of the first circuit substrate, the second timing control circuit of the second circuit substrate, and the third timing control circuit of the third circuit substrate are configured to provide a same timing control within the predetermined time, and the light-emitting chip units are divided into a plurality of first light-emitting chip units, a plurality of second light-emitting chip units and a plurality of third light-emitting chip units;
wherein the first light-emitting chip units are disposed on the first circuit substrate in a predetermined arrangement shape and are electrically connected to the first circuit substrate, and the first light-emitting chip units are configured to be not turned on simultaneously, thereby reducing heat transmitted from the first light-emitting chip units to the first circuit substrate;
wherein the second light-emitting chip units are disposed on the second circuit substrate in a predetermined arrangement shape and are electrically connected to the second circuit substrate, and the second light-emitting chip units are configured to be not turned on simultaneously, thereby reducing heat transmitted from the second light-emitting chip units to the second circuit substrate;
wherein the third light-emitting chip units are disposed on the third circuit substrate in a predetermined arrangement shape and are electrically connected to the third circuit substrate, and the third light-emitting chip units are configured to be not turned on simultaneously, thereby reducing heat transmitted from the third light-emitting chip units to the third circuit substrate;
wherein each of the first light-emitting chip units includes a red light-emitting chip configured to generate a red light beam, each of the second light-emitting chip units includes a green light-emitting chip configured to generate a green light beam, each of the third light-emitting chip units includes a blue light-emitting chip configured to generate a blue light beam, and the red light-emitting chips of the first light-emitting chip units, the green light-emitting chips of the third light-emitting chip units and the blue light-emitting chips of the third light-emitting chip unit are turned on through the same timing control within the predetermined time, thereby enabling the light providing module to generate the projection beam;
wherein the red light beam generated by the red light-emitting chip, the green light beam generated by the green light-emitting chip and the blue light beam generated by the blue light-emitting chip cooperate with each other to form a white light beam generated by each of the light-emitting chip units, and the red light-emitting chip, the green light-emitting chip and the blue light-emitting chip provided by each of the light-emitting chip units are all LED chips or laser diode chips;
wherein the image generating module includes a first digital micromirror chip, a second digital micromirror chip and a third digital micromirror chip;
wherein the first digital micromirror chip is configured to reflect the red light beam, thereby converting the red light beam into a first image light beam;
wherein the second digital micromirror chip is configured to reflect the green light beam, thereby converting the green light beam into a second image light beam;
wherein the third digital micromirror chip is configured to reflect the blue light beam, thereby converting the blue light beam into a third image light beam;
wherein the optical component module includes a first light-splitting prism disposed between the first light-emitting chip units of the light providing module, the first digital micromirror chip of the image generating module and the projection lens module, a second light-splitting prism disposed between the second light-emitting chip units of the light providing module, the second digital micromirror chip of the image generating module and the projection lens module, a third light-splitting prism disposed between the third light-emitting chip units of the light providing module, the third digital micromirror chip of the image generating module and the projection lens module, and a light-combining prism disposed between the first light-splitting prism, the second light-splitting prism and the third light-splitting prism;
wherein the optical component module includes a first collimator lens disposed between the first light-emitting chip units of the light providing module and the first light-splitting prism, a second collimator lens disposed between the second light-emitting chip units of the light providing module and the second light-splitting prism, and a third collimator lens disposed between the third light-emitting chip units of the light providing module and the third light-splitting prism;
wherein the first collimator lens is configured to adjust a first optical transmission path of the red light beam generated by each of the red light-emitting chips, the second collimator lens is configured to adjust a second optical transmission path of the green light beam generated by each of the green light-emitting chips, and the third collimator lens is configured to adjust a third optical transmission path of the blue light beam generated by each of the blue light-emitting chips;
wherein the first light-splitting prism is configured to reflect the red light beam generated by each of the red light-emitting chips onto the first digital micromirror chip, the second light-splitting prism is configured to reflect the green light beam generated by each of the green light-emitting chips onto the second digital micromirror chip, and the third light-splitting prism is configured to reflect the blue light beam generated by each of the blue light-emitting chips onto the third digital micromirror chip;
wherein the first light-splitting prism is configured to guide the first image beam generated by the first digital micromirror chip to the light-combining prism, the second light-splitting prism is configured to guide the second image beam generated by the second digital micromirror chip to the light-combining prism, and the third light-splitting prism is configured to guide the third image beam generated by the third digital micromirror chip to the light-combining prism;
wherein the light-combining prism is configured to collect the first image beam generated by the first digital micromirror chip, the second image beam generated by the second digital micromirror chip, and the third image beam generated by the third digital micromirror chip, thereby generating the image beam projected to the projection lens module;
wherein the projection lens module includes a lens assembly, and the lens assembly is configured to convert the image beam collected through the light-combining prism into a projection image projected on a predetermined screen;
wherein the light providing module, the image generating module, the optical component module and the projection lens module cooperate with each other to form a DLP projector using three single DMD chips.
